(19) United States
(12) Patent Application Publication
(10) Pub. No.: US 2025/0126606 A1
(43) Pub. Date: Apr. 17, 2025

(54) METHOD, DEVICE AND COMPUTER PROGRAM PRODUCT FOR WIRELESS COMMUNICATION

(71) Applicant: ZTE Corporation, Shenzhen (CN)

(72) Inventors: Weiqiang DU, Shenzhen (CN); Wei LUO, Shenzhen (CN); Lin CHEN, Shenzhen (CN)

(21) Appl. No.: 18/988,876

(22) Filed: Dec. 19, 2024

Related U.S. Application Data
(63) Continuation of application No. PCT/CN2022/129634, filed on Nov. 3, 2022.

(51) Int. Cl. H04W 72/02; H04W 72/40; H04W 72/56; H04W 74/0816

(52) U.S. Cl. CPC H04W 72/02; H04W 72/40; H04W 72/56; H04W 74/0816

(57) ABSTRACT

A wireless communication method is disclosed. The method comprises selecting, by a first wireless communication terminal, transmission resources for a sidelink communication with a second wireless communication terminal; and using, by the first wireless communication terminal, the selected transmission resources as a transmission grant for the sidelink communication with the second wireless communication terminal.

### CROSS-REFERENCE TO RELATED APPLICATIONS

This application is a continuation of International Patent Application No. PCT/CN2022/129634, filed on Nov. 3, 2022, the disclosure of which is incorporated herein by reference in its entirety.

### TECHNICAL FIELD

This document is directed generally to wireless communications, and in particular to 5th generation (5G) communications or 6th generation (6G) communications.

### BACKGROUND

With the development of wireless multimedia services, demands for high data rate and user experience are increasing, which puts forward higher requirements on the system capacity and coverage of traditional cellular networks. On the other hand, application scenarios such as public safety, social networking, close-range data sharing, and local advertising have gradually increased the need for people to understand and communicate with nearby people or things. The traditional base station-centric cellular network has limitations in terms of high data rate and support for proximity services. Accordingly, Device-to-Device (Device-to-Device, D2D) communication technology emerges. The application of D2D technology can reduce the burden of cellular networks, reduce battery power consumption of user equipment, increase data rate, and improve the robustness of network infrastructure, which can meet the requirements of the above-mentioned high data rate services and proximity services. D2D technology is also called Proximity Services (ProSe), unilateral, sidelink, or Sidelink (SL) communication; the interface between devices is PC5 interface.

### SUMMARY

This document relates to methods, systems, and computer program products for sidelink communications.

One aspect of the present disclosure relates to a wireless communication method. In an embodiment, the wireless communication method includes: selecting, by a first wireless communication terminal, transmission resources for a sidelink communication with a second wireless communication terminal; and using, by the first wireless communication terminal, the selected transmission resources as a transmission grant for the sidelink communication with the second wireless communication terminal.

Another aspect of the present disclosure relates to a wireless communication method. In an embodiment, the wireless communication method includes: receiving, by a first wireless communication terminal from a second wireless communication terminal, COT sharing information; and performing, by the first wireless communication terminal, a sidelink communication with the second wireless communication terminal based on the received COT sharing information.

Another aspect of the present disclosure relates to a wireless communication method. In an embodiment, the wireless communication method includes: receiving, by a first wireless communication terminal from a wireless communication node, a multiple consecutive slot transmission, MCSt, configuration; and performing, by the first wireless communication terminal, a sidelink communication with a second wireless communication terminal based on the MCSt configuration.

Another aspect of the present disclosure relates to a wireless communication method. In an embodiment, the wireless communication method includes: determining, by a first wireless communication terminal, a selected sidelink grant available for one or more retransmissions of a first Medium Access Control, MAC, Protocol Data Unit, PDU, which has been positively acknowledged, and transmitting, by a first wireless communication terminal, a second MAC PDU by using the selected sidelink grant which is available for the one or more retransmissions of the first MAC PDU which has been positively acknowledged.

Another aspect of the present disclosure relates to a wireless communication method. In an embodiment, the wireless communication method includes: selecting, by a first wireless communication terminal, transmission resources for a sidelink communication with a second wireless communication terminal from the candidate resources; and performing, by the first wireless communication terminal, the sidelink communication with the second wireless communication terminal by using the selected transmission resource.

Another aspect of the present disclosure relates to a wireless communication method. In an embodiment, the wireless communication method includes: obtaining, by a first wireless communication terminal a channel occupy time, COT; and performing a resource selection according to the obtained COT.

Another aspect of the present disclosure relates to a wireless communication terminal. In an embodiment, the wireless communication terminal includes a processor. The processor is configured to: select transmission resources for a sidelink communication with a second wireless communication terminal; and use the selected transmission resources as a transmission grant for the sidelink communication with the second wireless communication terminal.

Another aspect of the present disclosure relates to a wireless communication terminal. In an embodiment, the wireless communication terminal includes a transceiver and a processor. The processor is configured to: receive, via the transceiver from a second wireless communication terminal, COT sharing information; and perform a sidelink communication with the second wireless communication terminal based on the received COT sharing information.

Another aspect of the present disclosure relates to a wireless communication terminal. In an embodiment, the wireless communication terminal includes a transceiver and a processor. The processor is configured to: receive, via the transceiver from a wireless communication node, a multiple consecutive slot transmission, MCSt, configuration; and perform a sidelink communication with a second wireless communication terminal based on the MCSt configuration.

Another aspect of the present disclosure relates to a wireless communication terminal. In an embodiment, the wireless communication terminal includes a transceiver and a processor. The processor is configured to: determine a selected sidelink grant available for one or more retransmissions of a first Medium Access Control, MAC, Protocol Data Unit, PDU, which has been positively acknowledged, and transmit, via the transceiver a first wireless communication terminal, a second MAC PDU by using the selected sidelink grant which is available for the one or more retransmissions of the first MAC PDU which has been positively acknowledged.

Various embodiments may preferably implement the following features:

Preferably, the wireless communication method further comprises:
selecting transmission parameters, by a first wireless communication terminal, wherein
the transmission resources are selected based on the selected transmission parameters.

Preferably, the transmission parameters comprise N sets of transmission parameters, and N is an integer.

Preferably, one of the sets of transmission parameters comprises at least one of:
a hybrid automatic repeat request, HARQ, retransmission number,
a resource reselection counter value,
a transmission period,
a resource reservation interval,
an amount of frequency resources,
a packet delay budget,
a number of sub-channels, or
a resource pool.

Preferably, N sets of transmission parameters are selected as the selected transmission parameters according to priorities of logical channels of different destinations.

Preferably, N sets of transmission parameters corresponding to highest priority of a logical channel within N different destinations are selected as the selected transmission parameters.

Preferably, N sets of transmission parameters are selected as the selected transmission parameters according to priorities of logical channels among all destinations.

Preferably, N sets of transmission parameters corresponding to top N highest priorities of logical channels among different destinations are selected as the selected transmission parameters.

Preferably, in response to the transmission parameters being resource reservation intervals, the N resource reservation intervals are not divisible by each other.

Preferably, in response to the transmission parameters being resource reservation intervals, N resource reservation intervals for selecting the transmission resources are selected from more than one configured allowed resource reservation interval lists.

Preferably, a candidate resource adjacent to a selected transmission resource is selected as one of the transmission resources.

Preferably, a candidate resource with an interval relative to a selected transmission resource not greater than a channel occupancy time, COT, is selected as one of the transmission resources.

Preferably, the selected transmission resource comprises at least one of a selected initial transmission resource, a selected retransmission resource, or selected periodic transmission resource.

Preferably, a candidate resource is randomly selected as one of the transmission resources in response to no selected transmission resource existing.

Preferably, a candidate resource adjacent to a physical sidelink feedback channel, PSFCH, resource is selected as one of the transmission resources in response to PSFCH is configured.

Preferably, a candidate resource with an interval relative to a PSFCH resource not greater than a channel occupancy time, COT, is selected as one of the transmission resources in response to PSFCH is configured.

Preferably, the candidate resource is selected in response to the candidate resource being immediately before, immediately after, or consecutive to the selected transmission resource or the PSFCH resource.

Preferably, the each candidate resource includes N consecutive slots.

Preferably, the first wireless communication terminal selects one candidate resource as an initial transmission resource, and considers every slot in the selected initial transmission resource for initial transmission.

Preferably, the first wireless communication terminal selects one candidate resource as a re-transmission resource, and considers every slot in the selected re-transmission resource for re-transmission.

Preferably, the first wireless communication terminal selects N consecutive resources simultaneously.

Preferably, each resource of the N consecutive resources is for initial transmission.

Preferably, each resource of the N consecutive resources is for re-transmission.

Preferably, the first wireless communication terminal selects M*(N consecutive resource) simultaneously, each N consecutive resource is considered as a resource group, the first wireless communication terminal selects M resource groups, the resource within the resource group are consecutive, different resource groups are consecutive or not, and each resource of N consecutive resources is for one retransmission.

Preferably, wherein the COT sharing information comprises at least one of:
a Channel Access Priority Class, CAPC, value,
a COT shared by the second wireless communication terminal,
a duration of a COT shared by the second wireless communication terminal, or
identification information of one or more devices allowed to use a COT shared by the second wireless communication terminal.

Preferably, operations performed by the first wireless communication terminal in response to receiving the COT sharing information comprises at least one of:
triggering a resource reselection;
selecting a resource within a COT shared by the second wireless communication terminal;
triggering a resource reselection in response to a selected transmission resource that is not within a COT shared by the second wireless communication terminal;
indicating the COT sharing information to a lower layer;
randomly selecting a resource within a COT shared by the second wireless communication terminal in response to no sensing result existing in a reception of the COT sharing information;
selecting a resource within an intersection of a COT shared by the second wireless communication terminal and a sensing result of the first wireless communication terminal, in response to the first wireless communication terminal having the sensing result;
selecting a resource within a shared COT duration randomly, in response to random selection being configured on a resource pool; or
selecting a resource within an intersection of a COT shared by the second wireless communication terminal and a sensing result, in response to the first wireless communication terminal having the sensing result for data to be transmitted to the second wireless communication terminal.

Preferably, the MCSt configuration comprises at least one of:
an indication indicating whether an MCSt is enabled,
a packet size threshold for enabling an MCSt,
a buffer size threshold for enabling an MCSt, or
a data burst volume threshold for enabling an MCSt.
an integer indicating a number of consecutive slots to be selected for an MCSt,
an integer indicating a number of consecutive resources to be selected for an MCSt
an integer indicating a number of sets of transmission parameters to be selected for an MCSt.

Preferably, the MCSt configuration is carried by at least one of: a Radio Resource Control, RRC, configuration, a resource pool configuration, a radio bearer configuration, a Radio Link Control, RLC, configuration, or a logical channel configuration.

Preferably, the first wireless communication terminal considers the selected sidelink grant as an initial transmission grant to transmit the second MAC PDU.

Preferably, the first wireless communication terminal associates the selected sidelink grant to another HARQ process which is not empty and having one or more packets to be transmitted to transmit the second MAC PDU.

Preferably, the first wireless communication terminal considers that the selected sidelink grant is unselected to transmit the second MAC PDU.

Preferably, the first wireless communication terminal triggers a resource selection to transmit the second MAC PDU.

Preferably, the first wireless communication terminal associates the selected sidelink grant to another grant and considering the selected sidelink grant as a re-transmission of the another grant to transmit the second MAC PDU.

Preferably, the first wireless communication terminal, in response to the grant including more than one transmission resource, considers a first resource as an initial transmission grant, and a subsequent resource as a re-transmission grant to transmit the second MAC PDU.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of a resource selection according to an embodiment of the present disclosure.

FIG. 2 shows schematic diagram of a procedure according to an embodiment of the present disclosure.

FIG. 3 shows schematic diagram of a procedure according to an embodiment of the present disclosure.

FIG. 4 shows schematic diagram of a procedure according to an embodiment of the present disclosure.

FIG. 5 shows schematic diagram of a procedure according to an embodiment of the present disclosure.

FIG. 6 shows schematic diagram of a procedure according to an embodiment of the present disclosure.

FIG. 7 shows schematic diagram of a procedure according to an embodiment of the present disclosure.

FIG. 8 shows an example of a schematic diagram of a wireless communication terminal according to an embodiment of the present disclosure.

FIG. 9 shows a flowchart of a wireless communication method according to an embodiment of the present disclosure.

FIG. 10 shows a flowchart of a wireless communication method according to an embodiment of the present disclosure.

FIG. 11 shows a flowchart of a wireless communication method according to an embodiment of the present disclosure.

FIG. 12 shows a flowchart of a wireless communication method according to an embodiment of the present disclosure.

### DETAILED DESCRIPTION

In some embodiments, devices using the sidelink communication support two resource modes, mode 1 and mode 2. For mode 1, the UE (user equipment) may use the resource scheduled by the network to transmit sidelink data. For mode 2, the UE may select the transmission resource by itself to transmit sidelink data.

In some embodiments, the wireless communications are performed on carriers or frequency bands. Some carriers are licensed carriers, which are carriers licensed by a governmental or another authoritative entity to a service provider for an exclusive use. Some carriers are unlicensed carriers, which are carriers not licensed by the governmental or authoritative entity. In some embodiments, the user terminal devices (e.g., UEs) may be able to communicate directly with each other (i.e., without the use of a base station) on the licensed carriers. However, in some situation, ways for the user terminal devices to communicate directly with each other on unlicensed carriers may still be unclear.

Some embodiments of the present disclosure relate to how a wireless device (e.g., a UE) selects the resource when the wireless communication is performed on an unlicensed carrier (e.g., shared spectrum).

In the present disclosure, a licensed carrier is a carrier, frequency band or spectrum that is licensed by a government or other authoritative entity (e.g., the Federal Communications Commission (FCC) in the United States or the European Telecommunications Standards Institute (ETSI) in Europe) to a service provider for exclusive use. An unlicensed carrier, also called a shared spectrum, is a carrier, frequency band or spectrum that is not licensed by a government or other authoritative entity.

In some embodiments, when a user device (e.g., a UE) performs data transmission on an unlicensed carrier, the user device may perform a channel access scheme called LBT (listen before talk). During the LBT procedure, the user device monitors the channel for some time. If the result of the LBT procedure is a success, the user device can occupy the channel for a certain time called COT (channel occupy time). The LBT procedures included initial LBT (e.g. LBT type1) and non-initial LBT (e.g. LBT type2, 2a, 2b, 2c). Compared with non-initial LBT, UE needs more time to perform initial LBT procedure. The non-initial LBT is performed within a occupied COT.

The length of the COT (i.e., T_{ulm cot, p} or T_{m cot, p}) depends on a CAPC (Channel Access Priority Class) value used for the LBT procedure, for example, as shown in the tables below. In an event that the result of the LBT procedure is a success, the user device can share the COT with another user device. The user device can use the COT shared by other UE to perform channel access. In this case, non-initial LBT can be used for channel access.

| Channel | | | | | |
|---|---|---|---|---|---|
| Access | | | | | |
| Priority | | | | | allowed |
| Class (p) | mₚ | CW_{min, p} | CW_{max, p} | T_{m cot, p} | CWₚ sizes |
| 1 | 1 | 3 | 7 | 2 ms | {3, 7} |
| 2 | 1 | 7 | 15 | 3 ms | {7, 15} |
| 3 | 3 | 15 | 63 | 8 or 10 ms | {15, 31, 63} |
| 4 | 7 | 15 | 1023 | 8 or 10 ms | {15, 31, 63, 127, |
| | | | | | 255, 511, 1023} |
| Channel | | | | | |
| Access | | | | | |
| Priority | | | | | allowed |
| Class (p) | mₚ | CW_{min, p} | CW_{max, p} | T_{ulm cot, p} | CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or | {15, 31, 63, 127, |
| | | | | 10 ms | 255, 511, 1023} |
| 4 | 7 | 15 | 1023 | 6 ms or | {15, 31, 63, 127, |
| | | | | 10 ms | 255, 511, 1023} |

In some embodiments, when a user device uses sidelink resource allocation mode 2 to transmit data, in which sidelink resource allocation mode 2 including multiple mechanisms such as full sensing only, partial sensing only, random resource selection only, or any combination(s) thereof, the user device may perform the following operations:
Step 1: selecting the data transmission parameter including at least one of: a HARQ retransmission number, a resource reselection counter value, a transmission period, the resource reservation interval, an amount of frequency resources, a packet delay budget, the number of sub-channels to be used for the PSSCH/PSCCH transmission, a resource pool;
Step 2: using the selected data transmission parameter to determine candidate resource set (i.e. obtain sensing result); and
Step 3: selecting the initial transmission resource from the determined candidate resource set,
Step 4: if needed, select multiple re-transmission resource from the determined candidate resource set for the selected initial transmission resource in step 3, the number of re-transmission resource depends on the selected HARQ re-transmission number.
Step 5: if needed, select period transmission resource from the determined candidate resource set. The period depends on the resource reservation interval.

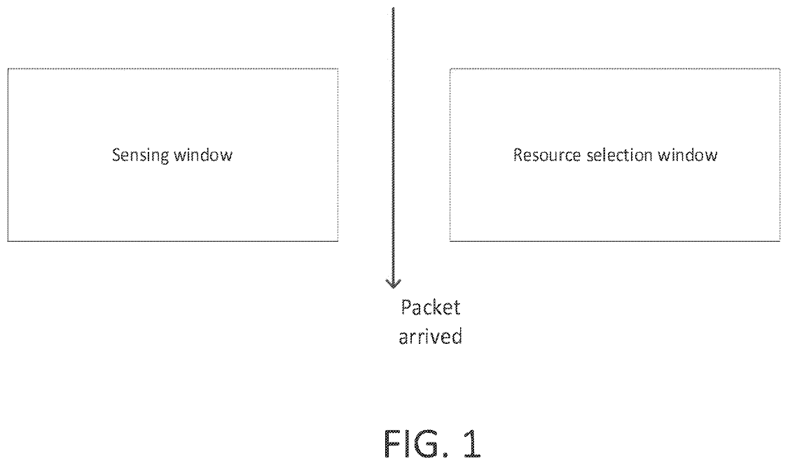

In some embodiments, to determine the candidate resource set in step 2, in sidelink resource allocation mode 2, the UEs may perform a sensing procedure to obtain sensing result (i.e. determine candidate resource). To obtain sensing result, the MAC module considers a single TB (transport block) transmission, characterized by a set of transmission parameters: resource pool, L1 priority, packet delay budget (PDB), number of subchannels L_subCH to be used in a slot, and optionally the resource reservation interval P_{rsvp_TX} in units of milliseconds. The MAC module asks the PHY module to exclude a set of resources in the selection window based on a sensing of subchannels. During the sensing window (see FIG. 1), the UE detects the level of RSRP over the slots where SCI-1 (SL control information) reservations were received, and projects it on the reserved resource under test. Each single slot in resource selection window is a resource, the UE determine all single slot resource in resource selection window as candidate resource. During the exclusion step, the said RSRP is tested against a threshold to assess the acceptability of the level of interference in case a collision may occur in said resource under test. After the exclusion procedure, the remaining resources in resource selection window are determined candidate resource set.

When sidelink communication is performed on unlicensed carrier, for each selected transmission resource, UE needs to perform channel access, and in response to channel access is success, UE can use the selected transmission resource to transmit sidelink data. Otherwise, in response to LBT failure, UE cannot use the selected transmission resource to transmit data.

In the paragraphs below, details will be described along with some aspects, but the present disclosure is not limited to the examples below.

### Aspect 1—Select Consecutive Resource on Unlicensed Carrier:

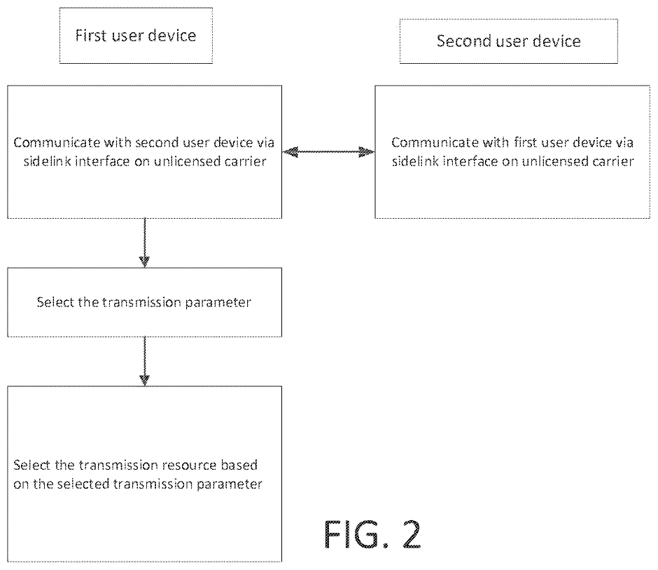

FIG. 2 shows schematic diagram of a procedure according to an embodiment of the present disclosure.

In one embodiment, in response to LBT is success, UE can occupy the channel for an amount of time (i.e. COT). However, in response to UE does not transmit the data for another amount of time within the COT, the channel may be occupied by other UE. In this case, UE lost its occupied COT and needs to perform initial LBT again to obtain a new COT. Therefore, in one embodiment, to maximize the usage of the occupied COT, UE needs to select consecutive resource, e.g., multiple consecutive slot transmission (MCSt) resources, N consecutive resource, N is an integer, the first resource is in 1st slot, the second resource is in 2nd slot and so on. To select consecutive resource, UE can select resource one by one, and ensure all the selected resource are consecutive, for example, UE select slot3 as transmission resource and then select slot4 as transmission. Or to select consecutive resource, UE can select N consecutive resource simultaneously, for example, UE select 2 consecutive resources, slot3 and slot4 as transmission resource are selected simultaneously.

In one embodiment, it may be hard to select the consecutive resource, then UE needs to select the transmission resource within the same COT as much as possible. For example, if UE select resource in slot n1 and slot n2, then n1−n2 or n2−n1 is not larger than a COT.

In one embodiment, the resource can include a single slot.

In one embodiment, the resource can include N consecutive slots.

In one embodiment, first wireless communication device selects N consecutive resource,
e.g. N consecutive resource, N is an integer, the first resource is in 1st slot, the second resource is in 2rd slot and so on.

In one embodiment, for the selected N consecutive resource, the first resource is for initial transmission and following M resources is for re-transmission of the first transmission, M is an integer, N=M+1. And if M+1 is smaller than N, then the M+2 resource is for initial transmission, the following M resource is for re-transmission and so on.

In one embodiment, first wireless communication device selects N consecutive resource simultaneously. Each resource of N consecutive resources is for initial transmission.

In one embodiment, the N consecutive resource are used to transmit different MAC PDU.

In one embodiment, first wireless communication device selects N consecutive resource simultaneously. Each resource of N consecutive resources is for one re-transmission.

In one embodiment, first wireless communication device selects M*(N consecutive resource) simultaneously. Each N consecutive resource can be considered as a resource group, first wireless communication device selects M resource groups. Then resource within the resource group is consecutive, different resource group can be consecutive or not. Each resource of N consecutive resources is for one re-transmission.

In one embodiment, M is an integer, and equal to the selected number of HARQ re-transmission.

In one embodiment, the number of consecutive resource (i.e. value N) is configured from second wireless communication device to first wireless communication device.

In some embodiments, when sidelink resource allocation mode 2 is used, if the first wireless communication device has a selected resource, first wireless communication device selects an adjacent resource of the selected resource. The adjacent resource and selected resource are consecutive slot resource.

If no adjacent resource is available to be selected, first wireless communication device selects the resource nearest to the selected resource.

In some embodiments, the adjacent resource is at least one of the following resource:
1. the resource immediately before the selected resource, for example, the selected resource is slot n, then the adjacent resource is slot n−1;
2. the resource immediately after the selected resource, for example, the selected resource is slot n, then the adjacent resource is slot n+1; or
3. the resource consecutive to the selected resource.

In some embodiments, the selected resource can be at least one of a selected initial transmission resource, a selected retransmission resource, or a selected period transmission resource.

In some embodiments, when sidelink resource allocation mode 2 is used, if first wireless communication device has no selected resource, the first wireless communication device may randomly select a resource.

In some embodiments, when sidelink resource allocation mode 2 is used, if the first wireless communication device has a selected resource, first wireless communication device may select the resource with an interval relative to a selected transmission resource not greater than a COT. For example, if the UE has a selected resource in slot n1, then resource slot n2 can be selected if n2−n1 or n1−n2 is not larger than the COT (e.g., 5 ms).

In some embodiments, when sidelink resource allocation mode 2 is used, for the retransmission resource, the first wireless communication device may select the adjacent resource of the selected resource as retransmission resource.

In some embodiments, when sidelink resource allocation mode 2 is used, for the retransmission resource, first wireless communication device may select the resource with an interval relative to a selected transmission resource not greater than a COT.

In one embodiment, it is possible that the LCH (i.e. logical channel) is HARQ enabled, in other words, after transmitting the data of this LCH, first wireless communication device needs to receives HARQ feedback on the configured PSFCH resource. And if TX UE sharing the COT after transmitting the data to RX UE, to allow RX UE use the shared COT performs LBT for HARQ feedback transmission. The transmission resource needs to go near the PSFCH resource as much as possible.

In some embodiments, if the LCH (logical channel) is HARQ enabled, the first wireless communication device may select the adjacent resource of the PSFCH resource.

In some embodiments, if the LCH is HARQ enabled, the first wireless communication device may select the resource with an interval relative to the PSFCH resource not greater than a COT.

In one embodiment, the adjacent resource of the PSFCH resource is at least one of following resource:
1. the resource immediately before the PSFCH resource. For example, the PSFCH resource is slot n, then the adjacent resource is slot n−1.
2. the resource consecutive to the PSFCH resource. For example, the PSFCH resource is slot n, then the adjacent resource is slot n+1.
3. the resource immediately after the PSFCH resource. For example, the PSFCH resource is slot n, then the adjacent resource is slot n+1.
4. the adjacent resource and PSFCH resource are in same slot.

### Aspect 2—Multiple Sensing Parameter Sets:

In one embodiment, to select consecutive transmission resource, MCSt (multiple consecutive slot transmission).

In one embodiment, selecting consecutive resource can be performed in step 2, the single slot resource is replaced by N consecutive slot resources. In other words, each candidate resource includes N consecutive slots.

Therefore, N set of transmission parameters may be needed to determine candidate resource includes N slot during sensing, then how UE select N sets of transmission parameters needs to be solved.

In some embodiments, when sidelink resource allocation mode 2 is used, the first wireless communication device may select N sets of transmission parameters for data transmission, for example, N sets of transmission parameters.

In some embodiments, each set of transmission parameters include at least one of: a HARQ retransmission number, a resource reselection counter value, a transmission period, the resource reservation interval, an amount of frequency resources, a packet delay budget, the number of sub-channels to be used for the PSSCH/PSCCH transmission, or a resource pool.

In some embodiments, if N sets of transmission parameters are needed to be selected, the first wireless communication device may select N sets of transmission parameters of the logical channel with the highest priority associated with different destinations (e.g., destination UEs).

In some embodiments, the first wireless communication device may sort the destinations according to the highest priority of the logical channels in each of the destinations. Then, the UE may select the N sets of transmission parameters corresponding to the logical channel with the Top N highest priority of the destinations. For example, under a condition that destination D1 has four logical channels LCH1, LCH2, LCH3, LCH4 respectively with priority 4, 5, 5, 5, destination D2 has four logical channels LCH1, LCH2, LCH3, LCH4 respectively with priority 4, 5, 2, 1, and destination D3 has four logical channels LCH1, LCH2, LCH3, LCH4 respectively with priority 4, 4, 3, 4, the UE may sort destinations D1, D2, D3 in an order D2, D3, D1. Then, if 2 sets of transmission parameters need to be selected, the UE may select the set of transmission parameters of logical channel LCH4 of destination D2 and the set of transmission parameters of logical channel LCH3 of destination D3.

For another example, TX UE has data to be transmitted to RX UE with following configuration (low priority value indicates high priority):
Destination RX UE1: LCH1 with priority value 1, LCH2 with priority value 2
Destination RX UE2: LCH1 with priority value 3, LCH2 with priority value 4
Destination RX UE3: LCH1 with priority value 3, LCH2 with priority value 2

Then all RX UEs are sorted as shown in following:
RX UE1 (highest priority LCH is 1), RX UE3 (highest priority LCH is 2), RX UE2 (highest priority LHC is 3).

Then, if N set of transmission parameter needs to be selected, TX (transmission) UE first select one set of transmission parameter of highest priority LCH in destination RX (Receiving) UE1, and then select another set of transmission parameter of highest priority LCH in destination RX UE3 and so on.

In some embodiments, if N sets of transmission parameters are needed to be selected, the first wireless communication device may select N sets of transmission parameters associated with different logical channels.

In some embodiments, the first wireless communication device may select the N sets of transmission parameters corresponding to the logical channels with the highest priorities among all destinations. For example, under a condition that destination D1 has four logical channels LCH1, LCH2, LCH3, LCH4 respectively with priority 4, 5, 5, 5, destination D2 has four logical channels LCH1, LCH2, LCH3, LCH4 respectively with priority 4, 5, 2, 1, and destination D3 has four logical channels LCH1, LCH2, LCH3, LCH4 respectively with priority 4, 4, 3, 4, the UE may select the set of transmission parameters of logical channel LCH4 of destination D2 and the set of transmission parameters of logical channel LCH3 of destination D2.

For another example, TX UE has data to be transmitted to RX UE with following configuration (low priority value indicates high priority):
Destination RX UE1: LCH1 with priority value 1, LCH2 with priority value 2
Destination RX UE2: LCH1 with priority value 3, LCH2 with priority value 4
Destination RX UE3: LCH1 with priority value 3, LCH2 with priority value 2

Then all LCHs are sorted in decreasing order of priority as shown in following:
LCH1 of RX UE1, LCH2 of RX UE1 or RX UE3, LCH1 of RX UE2 and RX UE3.

Then, if N set of transmission parameter needs to be selected, TX UE first select one set of transmission parameter of LCH1 of RX UE1, and then select another set of transmission parameter of LCH2 of RX UE2 or RX UE3 and so on.

In one embodiment, if N set of transmission parameter needs to be selected, then N resource reservation interval needs to be selected. The resource reservation interval may not be related to any logical channel. To solve this issue, following embodiment can be considered.

In some embodiments, if N sets of transmission parameters are needed to be selected, the first wireless communication device may select or determine multiple resource reservation intervals which are coprime to each other.

In some embodiments, N allowed resource reservation period lists are configured from a network device to the first wireless communication device. If N sets of transmission parameters are needed to be selected, first wireless communication device may select one resource reservation interval from each multiple allowed resource reservation period lists. For example, UE needs to select 2 sets of transmission parameters and 2 period list is configured, then UE select one period from first period list, and select one period from second period list.

In one embodiment, the number of set of transmission parameters (i.e. value N) is configured from second wireless communication device to first wireless communication device.

### Aspect 3—Resource Selection if MCST is Used:

In one embodiment, to select consecutive transmission resource, each candidate resource in step 2 may include N consecutive slots.

In one embodiment, in step 2, the single slot resource is replaced by N slot resource. In other words, each candidate resource includes N consecutive slot. However, since UE can only perform transmission one slot by one slot, how UE select the transmission resource and perform transmission when each candidate resource include N consecutive slots need to be solved.

In one embodiment, each slot in one candidate resource is used to transmit different MAC PDU.

In one embodiment, the number of consecutive slot (i.e. value N) is configured from second wireless communication device to first wireless communication device.

In one embodiment, if one candidate resource includes N consecutive slot, and first wireless communication device select one candidate resource as initial transmission resource, first wireless communication device considers every slot in the selected initial transmission resource is for initial transmission.

In one embodiment, if one candidate resource includes N consecutive slots, and first wireless communication device select one or more candidate resource as re-transmission resource, first wireless communication device considers every slot in the selected re-transmission resource is for re-transmission.

In one embodiment, if one candidate resource includes N consecutive slots, and first wireless communication device select one or more candidate resource as re-transmission resource, first wireless communication device considers each slot in the selected re-transmission resource is for re-transmission of the slot in selected initial transmission.

In one embodiment, the first slot in selected re-transmission resource is for re-transmission of the first slot in selected initial transmission, the second slot in selected re-transmission resource is for re-transmission of the second slot in selected initial transmission, and so on.

If one candidate resource includes N consecutive slot, and first wireless communication device select one resource, then the first slot in the resource is for initial transmission, and the following M slot in the resource is for re-transmission of the first slot. M is an integer and equal to the selected HARQ retransmission number. If N is larger than the M+1, then separate the resource into N/(M+1) part, each part includes M+1 slot, one slot in each part is for initial transmission and the remaining slot in each part is for re-transmission.

### Aspect 4:

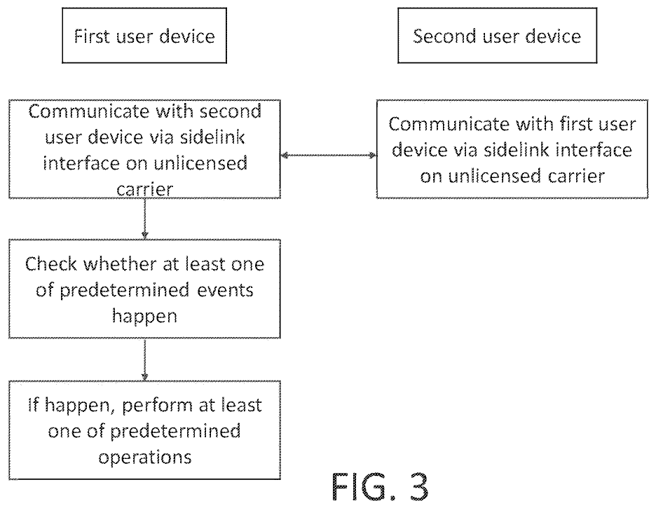

FIG. 3 shows schematic diagram of a procedure according to an embodiment of the present disclosure.

In one embodiment, in current specification, the SL grant may be ignored due to at least one of following:
1. if the HARQ Process ID corresponding to the sidelink grant received on PDCCH, the configured sidelink grant or the selected sidelink grant is associated to a Sidelink process of which HARQ buffer is empty; or
2. if the HARQ Process ID corresponding to the sidelink grant received on PDCCH is not associated to any Sidelink process; or
3. if PSCCH duration(s) and PSSCH duration(s) for one or more retransmissions of a MAC PDU of the dynamic sidelink grant or the configured sidelink grant is not in SL DRX Active time of the destination that has data to be sent:

Similarly, in current specification, UE will clear the PSCCH duration(s) and PSSCH duration(s) corresponding to retransmission(s) of the MAC PDU from the sidelink grant,
if a sidelink grant is available for retransmission(s) of a MAC PDU which has been positively acknowledged.

However, it is possible that the sidelink grant is selected for consecutive transmission or within a same COT, if the grant (G1) is to be ignored or cleared, then the transmission is no longer consecutive, and UE may lose the occupied COT. To maximize the occupied COT, if the above condition is met, UE can use this grant (G1) to transmit other MAC PDU for initial transmission or re-transmission. And optionally, select more re-transmission resource and associate this resource to this grant (G1).

In some embodiments, if the grant is to be ignored, the first wireless communication device performs at least one of the following:
1. considering the grant as an initial transmission grant;
2. associating the grant with another HARQ process which is not empty and consider the as re-transmission, i.e. the HARQ process has packet to be transmitted;
3. considering the grant is unselected resource;
4. triggering a resource selection.
5. associating the grant to another grant and considering it as re-transmission of another grant, or
6. If the grant includes more than one transmission resource, consider first resource as initial transmission grant, and following resource as re-transmission.

In some embodiments, if the HARQ Process ID corresponding to the sidelink grant, the configured sidelink grant or the selected sidelink grant is associated with a sidelink process of which HARQ buffer is empty, the first wireless communication device performs at least one of the following:
1. considering the grant as an initial transmission grant;
2. associating the retransmission grant to another HARQ process which is not empty and consider the as re-transmission, i.e. the HARQ process has packet to be transmitted;
3. considering the grant is unselected;
4. triggering a resource selection; or
5. associating the grant to another grant and considering it as re-transmission of another grant.
6. If the grant includes more than one transmission resource, consider first resource as initial transmission grant, and following resource as re-transmission.

In some embodiments, if the HARQ process ID corresponding to the sidelink grant received on PDCCH is not associated with any sidelink process, the first wireless communication device performs at least one of the following:
1. considering the grant as an initial transmission grant;
2. associating the retransmission grant to another HARQ process which is not empty and consider the as re-transmission, i.e. the HARQ process has packet to be transmitted;
3. considering the grant is unselected;
4. trigger a resource selection; or
5. associating the grant to another grant and considering it as re-transmission of another grant.
6. If the grant includes more than one transmission resource, consider first resource as initial transmission grant, and following resource as re-transmission.

In some embodiments, if a selected sidelink grant is available for retransmission(s) of an MAC PDU which has been positively acknowledged, the first wireless communication device performs at least one of the following:
1. considering the grant as an initial transmission grant;
2. associating the grant to another HARQ process which is not empty and consider it as re-transmission, i.e. the HARQ process has packet to be transmitted;
3. considering the grant is unselected;
4. trigger a resource selection; or
5. associating the grant to another grant and considering it as re-transmission of another grant.
6. If the grant includes more than one transmission resource, consider first resource as initial transmission grant, and following resource as re-transmission.

In some embodiments, if PSCCH duration(s) and PSSCH duration(s) for one or more retransmissions of a MAC PDU of the dynamic sidelink grant or the configured sidelink grant is not in SL DRX Active time of the destination that has data to be sent, the first wireless communication device performs at least one of the following:
1. considering the grant as an initial transmission grant;
2. associating the grant to another HARQ process which is not empty and consider the as re-transmission, i.e. the HARQ process has packet to be transmitted;
3. considering the grant is unselected;
4. trigger a resource selection;
5. associating the grant to another grant and considering it as re-transmission of another grant; or
6. If the grant includes more than one transmission resource, consider first resource as initial transmission grant, and following resource as re-transmission.

In some embodiments, if the selected HARQ retransmission resource fails to transmit due LBT failure, select another batch of retransmission resources for the MAC PDU that has been buffered in the HARQ process.

In one embodiment, for the MAC PDU that has been buffered in the HARQ process, in response to the actual number of re-transmission is smaller than the allowed re-transmission number, select another batch of retransmission resources for this MAC PDU.

In one embodiment, for the MAC PDU that has been buffered in the HARQ process, in response to the actual number of re-transmission is smaller than the allowed re-transmission number due to LBT failure, select another batch of retransmission resources for this MAC PDU.

In one embodiment, for each transmission of MAC PDU, counter M is set to the value of selected number of re-transmission. If first wireless communication device transmits the MAC PDU, then counter M−1. In other words, due to LBT failure or something else (e.g. intra-UE prioritization), if first wireless communication may does not transmit the MAC PDU, the counter should not minus one. If the counter is not equal to zero when all selected re-transmission resource is exhausted, then select another batch of retransmission resources for this MAC PDU select another batch of retransmission resources for this MAC PDU

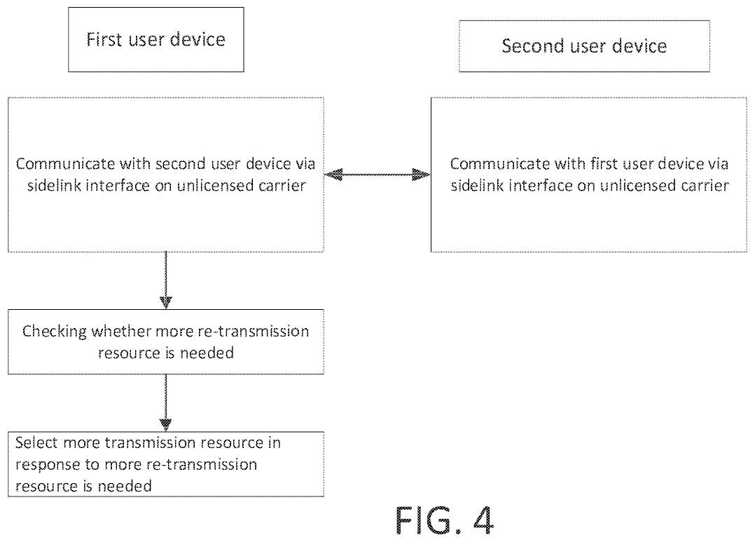

FIG. 4 shows schematic diagram of a procedure according to an embodiment of the present disclosure.

In one embodiment, for a sidelink grant, UE needs to perform channel access, however, it is possible that the channel access is failure. For one MAC PDU, it is also possible that UE select N transmission resource for initial transmission and re-transmission of one MAC PDU, however, due to channel access failure, UE only transmit the MAC PDU M times, where M<N, this is not fairness for this MAC PDU, to continue transmit the MAC PDU, UE can select more transmission resource for this MAC PDU.

In one embodiment, if first wireless communication device considers more retransmission(s) of the MAC PDU is required, first wireless communication device select N resources for re-transmission for this MAC PDU.

In one embodiment, if first wireless communication device considers more retransmission(s) of the MAC PDU is required, first wireless communication device select N resources for re-transmission for this MAC PDU.

In one embodiment, if HARQ feedback has been disabled for the MAC PDU, up to first wireless communication device implementation to judge whether more retransmission is needed or not.

In one embodiment, first wireless communication device considers more retransmission of the MAC PDU is required in response to the actual number of re-transmission is smaller than the allowed re-transmission number.

In one embodiment, first wireless communication device considers more retransmission of the MAC PDU is required in response to the last transmission is not success.

In one embodiment, first wireless communication device considers more retransmission of the MAC PDU is required in response to no more selected transmission is available for transmission.

In one embodiment, first wireless communication device considers more retransmission of the MAC PDU is required in response to HARQ feedback has been enabled for the MAC PDU, and MAC PDU has not been positively acknowledged

In one embodiment, first wireless communication device considers more retransmission of the MAC PDU is required if HARQ feedback has been enabled for the MAC PDU, and the last transmission of the MAC PDU has been negatively acknowledged.

In one embodiment, first wireless communication device considers more retransmission of the MAC PDU is required if HARQ feedback has been enabled for the MAC PDU, and the last transmission of the MAC PDU has no acknowledged.

In one embodiment, first wireless communication device considers more retransmission of the MAC PDU is required if HARQ feedback has been enabled for the MAC PDU, and the last transmission of the MAC PDU has been negatively acknowledged (i.e. HARQ NACK), and the number of re-transmission is less than the selected number of retransmission number.

In one embodiment, first wireless communication device considers more retransmission of the MAC PDU is required if HARQ feedback has been enabled for the MAC PDU, and the last transmission of the MAC PDU has no acknowledged (i.e. no HARQ feedback is received), and the number of re-transmission is less than the selected number of retransmission number.

In one embodiment, first wireless communication device considers more retransmission of the MAC PDU is required if HARQ feedback has been enabled for the MAC PDU, and the last transmission of the MAC PDU has been negatively acknowledged, and at least one of the transmission resource detect LBT failure.

In one embodiment, first wireless communication device considers more retransmission of the MAC PDU is required if HARQ feedback has been enabled for the MAC PDU, and the last transmission of the MAC PDU has no acknowledged, and at least one of the transmission resource detect LBT failure.

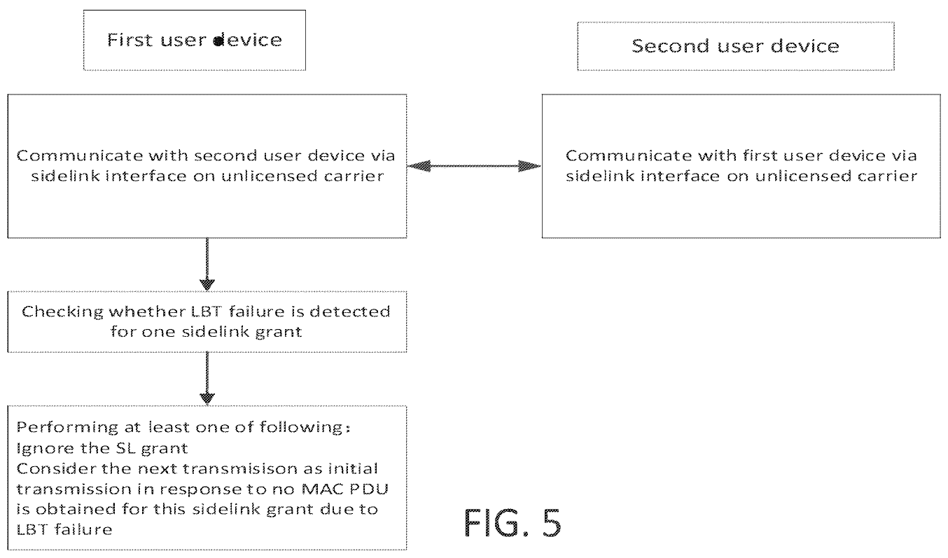

FIG. 5 shows schematic diagram of a procedure according to an embodiment of the present disclosure.

In one embodiment, for one sidelink grant, UE needs to perform channel access for this sidelink grant, and it is possible that channel access may fails. Then how to handle this sidelink grant needs to be solved, otherwise UE does not know how to handle this grant. In this case, UE needs to ignore the sidelink grant if the LBT failure is indicated for this SL grant.

In one embodiment, first wireless communication device obtains more than one SL grant in mode1 or mode2, the first grant is for initial transmission and following grant is for re-transmission. However, it is possible that the LBT failure is detected on the initial transmission, in this case, the following re-SL grant can be used for initial transmission. To be specifically, UE obtains grant G1 for initial transmission and G2 for re-transmission. for a sidelink grant G2, in response to no MAC PDU has been obtained in the previous sidelink grant G1 for transmission in response to LBF failure is detected on previous sidelink grant G1, this sidelink grant G2 can be used for initial transmission.

### Aspect 5—SCI Enhancement for MCST:

In one embodiment, DRX configuration may be configured to RX UE to save energy. RX UE will remain active to receives the SL data in defined active (e.g. when activity timer is running). When MCSt is used by TX UE, then RX UE may identify which consecutive slot is reserved by TX UE by reading the consecutive slot reservation information indicated by the SCI, therefore the active time of RX UE can include the consecutive slot indicated by the SCI.

In some embodiments, if the DRX (discontinuous reception) is configured, the active time of the first wireless communication device includes the consecutive transmission slot indicated by the SCI.

### Aspect 6—Condition for Starting MCST:

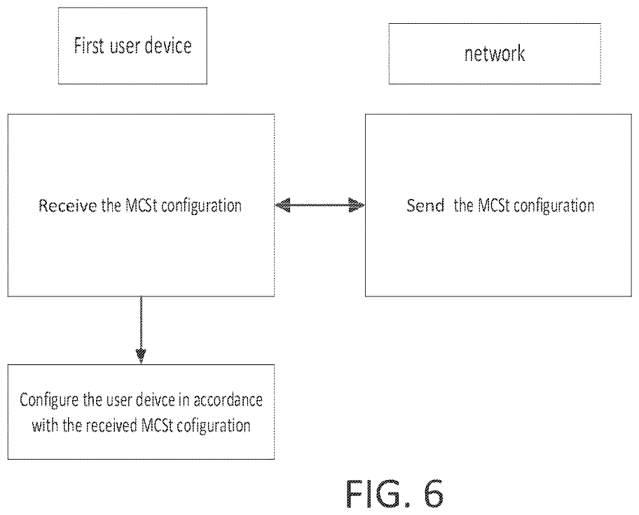

FIG. 6 shows schematic diagram of a procedure according to an embodiment of the present disclosure.

In one embodiment, MCSt enabling UE to select N consecutive transmission resources. However, this may be hard to realized and not fairness for other UE. Therefore, MCSt should be enabled based on some predefined conditions.

In some embodiments, the condition for enabling the selecting consecutive resource includes at least one of:
1. a packet size is large than a configured threshold;
2. a buffer size of a logical channel is larger than a configured threshold;
3. the UE is configured to enable the selecting consecutive resource;
4. a data burst volume for a QoS flow is not zero;
5. a data burst volume for a QoS flow is large than a configured threshold;

In some embodiments, the network device may send the MCSt configuration to the UE. The MCSt configuration may include at least one of: an indication indicating whether the selecting consecutive resource is enabled, the packet size threshold for enabling selecting consecutive resource, the buffer size threshold for enabling selecting consecutive resource, the data burst volume threshold for enabling selecting consecutive resource, an integer indicating a number of consecutive slots to be selected for selecting consecutive resource; an integer indicating a number of consecutive resources to be selected for selecting consecutive resource; or an integer indicating a number of sets of transmission parameters to be selected for selecting consecutive resource.

In some embodiments, the MCSt configuration is included in at least one of the following configuration: an RRC configuration, a resource pool configuration, a radio bearer configuration, an RLC configuration, a logical channel configuration.

In one embodiment, the MCSt configuration is configured at least one of per resource pool, per logical channel, per priority, per CAPC value, per radio bearer, per RLC channel.

Aspect 7—Actions after Receiving the COT Sharing Information:

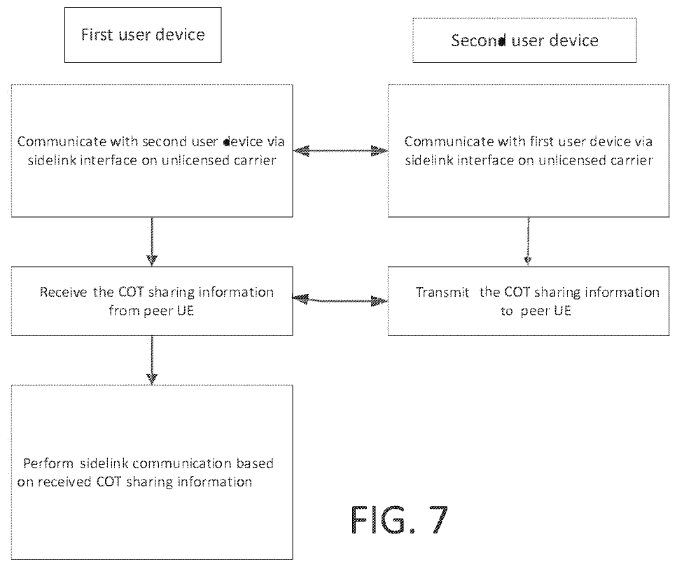

FIG. 7 shows schematic diagram of a procedure according to an embodiment of the present disclosure.

In one embodiment, in response to LBT is success, UE can occupy the channel for a COT. In another embodiment, if UE does not have enough packet to be transmitted for this COT, UE can share the remaining COT to other UE, so that other UE does not need to perform initial channel to obtain COT.

In one embodiment, the COT is obtained in response to LBT performed by first wireless communication device is success. In other words, the COT is occupied by UE self, not shared by other UE. In one embodiment, the COT is obtained in response to the COT is shared by other second wireless communication device.

Irrespective the COT is obtained by itself or received from other second wireless communication device, to maximize the usage of the COT, resource selection needs take COT into consideration, following embodiment can be considered.

In some embodiments, in response to the COT is obtained, the first wireless communication device performs at least one of the following:
1. triggering a resource reselection.
2. selecting the resource within the obtained COT.
3. if the selected transmission resource is not within the obtained COT, triggering a resource reselection.
4. indicating the obtained COT to a lower layer, for example, a PHY layer.
5. if no sensing result (e.g., the determined candidate resource in step 2 is empty or has not finished step 2) exists in the obtained COT, randomly selecting the resource within the COT shared by second wireless communication device.
6. selecting a resource within an intersection of a obtained COT and a sensing result of the first wireless communication device, in response the first wireless communication device having the sensing result.
7. selecting a resource within an obtained COT randomly, in response to random selection being configured on a resource pool. 8. selecting a resource within an obtained of a COT and a sensing result, in response to the UE having the sensing result for data to be transmitted to the second wireless communication device.
9. selecting a resource within an intersection of obtained COT and a sensing result, in response to the first wireless communication terminal having the sensing result, and the resource is used for data to be transmitted to the second wireless communication terminal, in response to the COT is obtained by receiving the COT sharing information from the second wireless communication terminal.

In one embodiment, a first signaling can be used to transmit the COT sharing information. The first signaling can be at least one of following: MAC CE, RRC signaling.

In one embodiment, first wireless communication device is configured to whether resource selection needs to take COT into consideration by the network.

In one embodiment, before receiving the COT sharing information from second wireless communication device, first wireless communication device can transmit a COT assistance information to second wireless communication device for second wireless communication device to determine the appropriate COT.

In one embodiment, the COT assistance information included: CAPC value

In one embodiment, the COT assistance information included: resource reservation interval.

In one embodiment, the COT assistance information included: buffer size.

In one embodiment, the COT assistance information included: preferred COT sharing information to be used for transmission.

In one embodiment, the COT assistance information included: non-preferred COT sharing information to be used for transmission.

The COT assistance information can be included in a COT request signaling to request peer UE to send the COT sharing information.

### Aspect 8-RLF Detection:

In some embodiments of the UE performing the sidelink communications, the UE transmits the data on a PSSCH (physical sidelink shared channel) and receives a HARQ feedback on a PSFCH (physical sidelink feedback channel). Based on the HARQ feedback on PSFCH, each PSSCH resource is associated with one PSFCH resource. The UE can therefore perform the HARQ-based sidelink RLF (radio link failure) detection, i.e., detecting the sidelink RLF based on the HARQ feedback on the PSFCH resource. Specifically, if the number of consecutive PSFCHs absent reaches the maximum value, the UE considers/determines that the SL RLF is detected.

However, when the unlicensed band is used as the PSFCH resource, it is possible that the LBT failure is detected on the PSFCH resource. To solve this issue, the UE can transmit the corresponding HARQ feedback via an MAC CE, not via the PSFCH resource.

In an embodiment, in response to that the UE receives the HARQ feedback via the MAC CE, the UE may perform the following operations:
Step 1: if the MAC CE including HARQ feedback of PSSCH transmission is absent for the PSSCH transmission, increment numConsecutiveDTX (i.e., an integer variable) by 1, otherwise re-initialize/set the numConsecutiveDTX to zero.
Step 2: if the numConsecutiveDTX reaches the maximum value, indicating a HARQ-based sidelink RLF detection to an RRC layer entity.

In some embodiments, first wireless communication device may perform the following operations:

If the MAC CE including the HARQ feedback of a PSSCH transmission is absent for the PSSCH transmission, increment numConsecutiveDTX by 1. If the MAC CE including the HARQ feedback of a PSSCH transmission is absent for the PSSCH transmission and if numConsecutiveDTX reaches sl-maxNumConsecutiveDTX, indicating HARQ-based sidelink RLF detection to RRC.

If the MAC CE including the HARQ feedback of a PSSCH transmission is received for the PSSCH transmission, re-initializing numConsecutiveDTX to zero.

In one embodiment, if first signaling is used for HARQ feedback information, transmission parameter of this HARQ feedback need to be configured for first wireless communication device to perform HARQ feedback signaling transmission. Transmission information includes at least one of a latency bound, a priority for sensing, a priority for candidate resource (re-) selection, a priority for logical channel prioritization.

In one embodiment, the transmission information can be configured by at least one of second wireless communication device, network.

In one embodiment, first signaling can be at least one of MAC CE, RRC signaling.

For UE1 performing SL communication on unlicensed band, after receiving the COT sharing from peer UE2, for one sidelink grant, UE1 use the shared COT to perform channel access (i.e. LBT procedure) for the sidelink grant. In this case, it is possible that for the COT shared by UE2, if UE1 use the COT shared by UE2 to perform channel access, then UE1 can only use this grant to transmit data to UE2, in other words the COT shared by UE2 can only be used by the SL data of UE2. For example, UE1 has data to be transmitted to UE2 and UE3 respectively. UE1 receives the COT shared by UE2 and determine to use this shared COT to perform channel access for the sidelink grant. Then, UE1 can use this sidelink grant to transmit the data of UE2. Data of UE3 cannot use this SL grant. Furthermore, only if data of UE2 is not available, data of UE3 can use this grant to be transmitted UE3. In other words, in case no UE2's data is available to be transmitted, UE1 can use this sidelink grant to transmit the data UE3.

In one embodiment, first wireless communication device is configured with whether the data of second wireless communication device can use the SL grant, in response to first wireless communication device use the COT shared by third wireless communication device to perform channel access for this SL grant.

In one embodiment, for a sidelink grant, when performing LCP, the destination (e.g. second wireless communication device) is selected by first wireless communication device for selecting logical channel to be multiplexed into the MAC PDU if the destination meet: the SL grant is within the COT shared by the destination (e.g. second wireless communication device)

In one embodiment, the destination is the second wireless communication device.

In one embodiment, for a sidelink grant, when performing LCP, the destination (e.g. third wireless communication device) is selected by first wireless communication device for selecting logical channel to be multiplexed into the MAC PDU if the destination meet: the SL grant is within the COT shared by second wireless communication device, and the data of the destination (e.g. second wireless communication device) sharing the COT is empty.

In one embodiment, for a sidelink grant, when performing LCP, by first wireless communication device, the destination (e.g. second wireless communication device) is selected for selecting logical channel to be multiplexed into the MAC PDU if the destination meet: first wireless communication device receives the COT shared by the destination (e.g. second wireless communication device), and use the COT shared by this destination (e.g. second wireless communication device) to perform channel access for the SL grant.

In one embodiment, for a sidelink grant, when performing LCP, by first wireless communication device, the destination (e.g. second wireless communication device) is selected for selecting logical channel to be multiplexed into the MAC PDU if the destination meet: first wireless communication device receives the COT shared by the another destination (e.g. third wireless communication device), and the SL grant use the COT shared by another destination (e.g. third wireless communication device) to perform channel access, and no data of the another destination (e.g. third wireless communication device) sharing the COT is available for transmission.

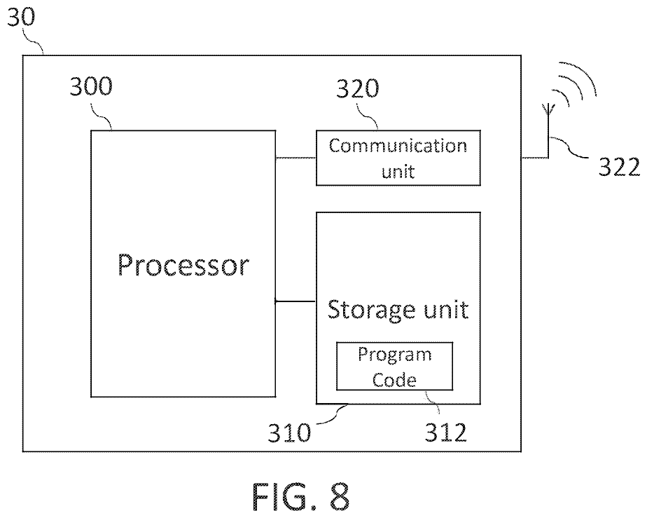

FIG. 8 relates to a diagram of a wireless communication terminal 30 according to an embodiment of the present disclosure. The wireless communication terminal 30 may be a tag, a mobile phone, a laptop, a tablet computer, an electronic book or a portable computer system and is not limited herein. The wireless communication terminal 30 may include a processor 300 such as a microprocessor or Application Specific Integrated Circuit (ASIC), a storage unit 310 and a communication unit 320. The storage unit 310 may be any data storage device that stores a program code 312, which is accessed and executed by the processor 300. Embodiments of the storage code 312 include but are not limited to a subscriber identity module (SIM), read-only memory (ROM), flash memory, random-access memory (RAM), hard-disk, and optical data storage device. The communication unit 320 may a transceiver and is used to transmit and receive signals (e.g., messages or packets) according to processing results of the processor 300. In an embodiment, the communication unit 320 transmits and receives the signals via at least one antenna 322.

In an embodiment, the storage unit 310 and the program code 312 may be omitted and the processor 300 may include a storage unit with stored program code.

The processor 300 may implement any one of the steps in exemplified embodiments on the wireless communication terminal 30, e.g., by executing the program code 312.

The communication unit 320 may be a transceiver. The communication unit 320 may as an alternative or in addition be combining a transmitting unit and a receiving unit configured to transmit and to receive, respectively, signals to and from another wireless communication terminal or a network device.

In some embodiments, the wireless communication terminal 30 may be used to perform the operations of the UE or the user device described above. In some embodiments, the processor 300 and the communication unit 320 collaboratively perform the operations described above. For example, the processor 300 performs operations and transmit or receive signals, message, and/or information through the communication unit 320.

A wireless communication method is also provided according to an embodiment of the present disclosure. In an embodiment, the wireless communication method may be performed by using a wireless communication terminal (e.g., a UE). In an embodiment, the wireless communication terminal may be implemented by using the wireless communication terminal 40 described above, but is not limited thereto.

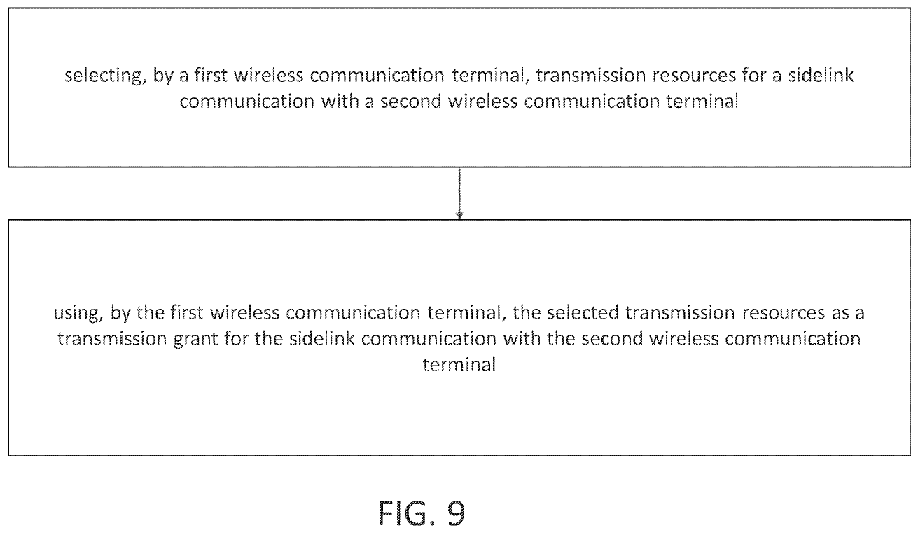

Referring to FIG. 9, in an embodiment, the wireless communication method includes: selecting, by a first wireless communication terminal, transmission resources for a sidelink communication with a second wireless communication terminal; and using, by the first wireless communication terminal, the selected transmission resources as a transmission grant for the sidelink communication with the second wireless communication terminal.

Details in this regard can be ascertained with reference to the paragraphs above, and will not be repeated herein.

Another wireless communication method is also provided according to an embodiment of the present disclosure. In an embodiment, the wireless communication method may be performed by using a wireless communication terminal (e.g., a UE). In an embodiment, the wireless communication terminal may be implemented by using the wireless communication terminal 40 described above, but is not limited thereto.

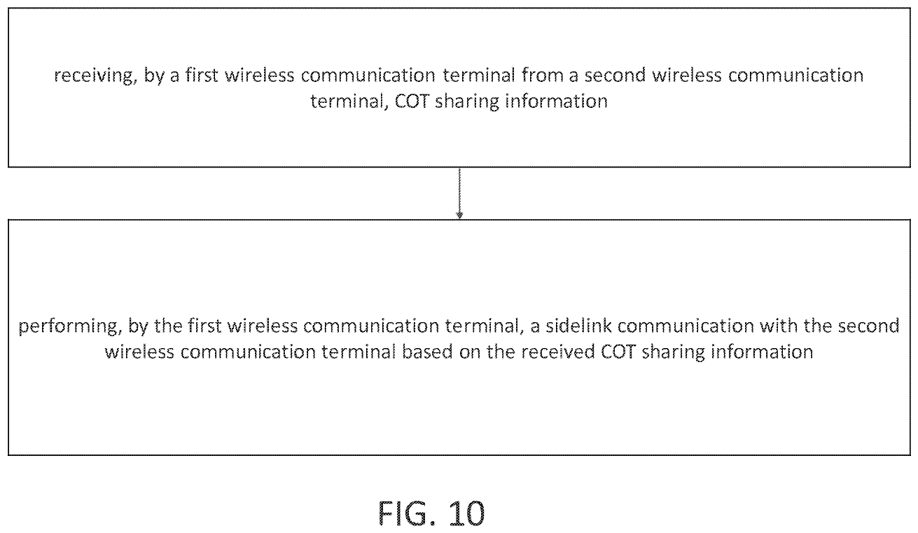

Referring to FIG. 10, in an embodiment, the wireless communication method includes: receiving, by a first wireless communication terminal from a second wireless communication terminal, COT sharing information; and performing, by the first wireless communication terminal, a sidelink communication with the second wireless communication terminal based on the received COT sharing information.

Details in this regard can be ascertained with reference to the paragraphs above, and will not be repeated herein.

Another wireless communication method is also provided according to an embodiment of the present disclosure. In an embodiment, the wireless communication method may be performed by using a wireless communication terminal (e.g., a UE). In an embodiment, the wireless communication terminal may be implemented by using the wireless communication terminal 40 described above, but is not limited thereto.

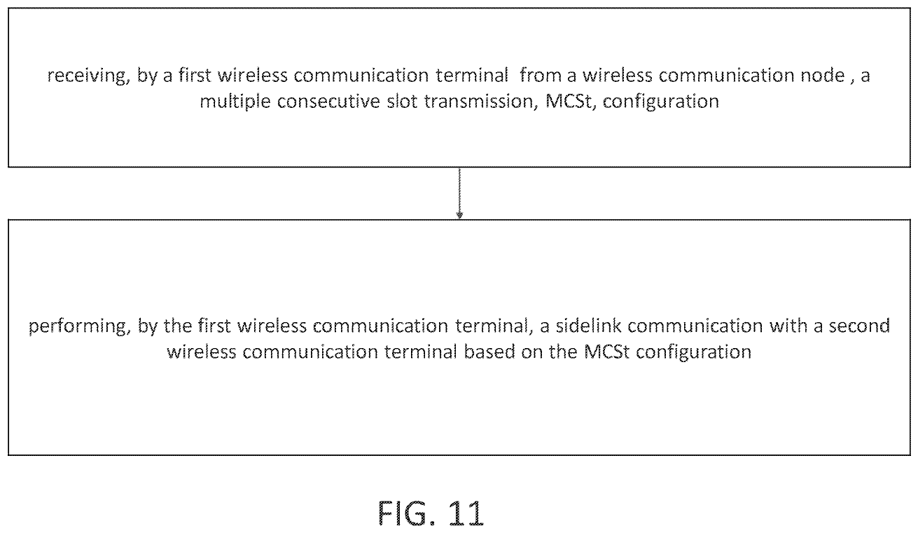

Referring to FIG. 11, in an embodiment, the wireless communication method includes: receiving, by a first wireless communication terminal from a wireless communication node, a multiple consecutive slot transmission, MCSt, configuration; and performing, by the first wireless communication terminal, a sidelink communication with a second wireless communication terminal based on the MCSt configuration.

Details in this regard can be ascertained with reference to the paragraphs above, and will not be repeated herein.

Another wireless communication method is also provided according to an embodiment of the present disclosure. In an embodiment, the wireless communication method may be performed by using a wireless communication terminal (e.g., a UE). In an embodiment, the wireless communication terminal may be implemented by using the wireless communication terminal 40 described above, but is not limited thereto.

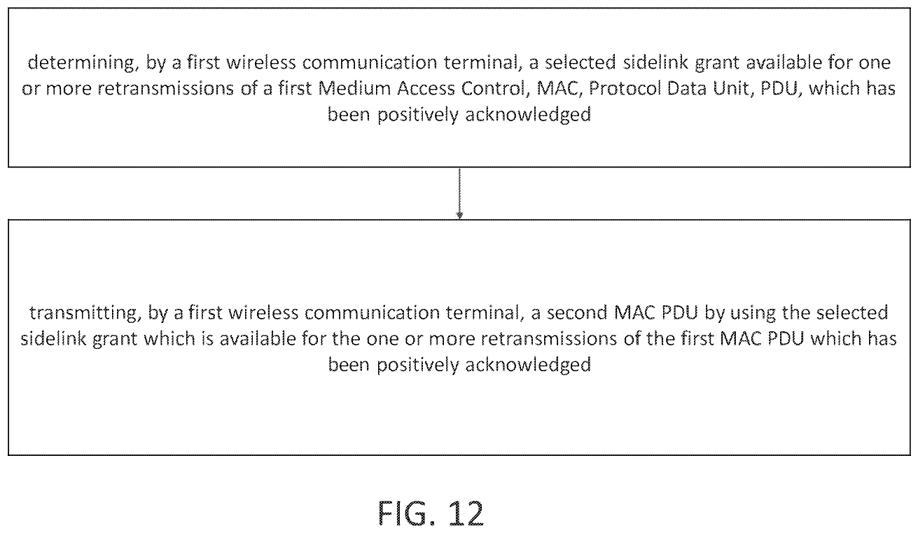

Referring to FIG. 12, in an embodiment, the wireless communication method includes: determining, by a first wireless communication terminal, a selected sidelink grant available for one or more retransmissions of a first Medium Access Control, MAC, Protocol Data Unit, PDU, which has been positively acknowledged, and transmitting, by a first wireless communication terminal, a second MAC PDU by using the selected sidelink grant which is available for the one or more retransmissions of the first MAC PDU which has been positively acknowledged.

Details in this regard can be ascertained with reference to the paragraphs above, and will not be repeated herein.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

What is claimed is:

1. A wireless communication method comprising:
selecting, by a first wireless communication terminal, transmission resources for a sidelink communication with a second wireless communication terminal from candidate resources; and
performing, by the first wireless communication terminal, the sidelink communication with the second wireless communication terminal by using the transmission resources.

2. The wireless communication method of claim 1, further comprising:
selecting transmission parameters, by the first wireless communication terminal, wherein the transmission resources are selected based on the transmission parameters.

3. The wireless communication method of claim 2, wherein the transmission parameters comprise N sets of transmission parameters, and N is an integer;
wherein one of the N sets of transmission parameters comprises any one or more of:
a hybrid automatic repeat request, HARQ, retransmission number,
a resource reselection counter value,
a transmission period,
a resource reservation interval,
an amount of frequency resources,
a packet delay budget,
a number of sub-channels, or
a resource pool.

4. The wireless communication method of claim 3,
wherein the N sets of transmission parameters are selected as the transmission parameters according to priorities of logical channels of different destinations; or
wherein the N sets of transmission parameters corresponding to highest priority of a logical channel within N different destinations are selected as the transmission parameters.

5. The wireless communication method of claim 3,
wherein the N sets of transmission parameters are selected as the transmission parameters according to priorities of logical channels among all destinations; or
wherein the N sets of transmission parameters corresponding to top N highest priorities of logical channels among all destinations are selected as the transmission parameters.

6. The wireless communication method of claim 1, further comprising:
selecting consecutive resource by the first wireless communication terminal by selecting a candidate resource adjacent to a selected transmission resource as one of the transmission resources.

7. The wireless communication method of claim 1, wherein a candidate resource with an interval relative to a selected transmission resource not greater than a channel occupancy time (COT) is selected as one of the transmission resources.

8. The wireless communication method of claim 1, wherein a candidate resource adjacent to a physical sidelink feedback channel (PSFCH) resource is selected as one of the transmission resources in response to the PSFCH being configured.

9. The wireless communication method of claim 1, wherein a candidate resource with an interval relative to a PSFCH resource not greater than a channel occupancy time (COT) is selected as one of the transmission resources in response to PSFCH is configured.

10. The wireless communication method of claim 6, wherein the candidate resource is selected in response to the candidate resource being immediately before, immediately after, or consecutive to the selected transmission resource or a physical sidelink feedback channel (PSFCH) resource.

11. The wireless communication method of claim 1, further comprising:
selecting consecutive resource by the first wireless communication terminal by including N consecutive slots in each candidate resource.

12. The wireless communication method of claim 11, wherein the first wireless communication terminal selects one candidate resource as an initial transmission resource, and considers every slot in the initial transmission resource for initial transmission.

13. The wireless communication method of claim 11, wherein the first wireless communication terminal selects one candidate resource as a re-transmission resource, and considers every slot in an initial transmission resource for re-transmission; or wherein a first slot in a resource is for initial transmission, and following slots in the resource is for re-transmission of the first slot.

14. The wireless communication method of claim 1, further comprising:
obtaining, by the first wireless communication terminal a channel occupy time (COT); and
performing a resource selection according to the COT.

15. The wireless communication method of claim 14 wherein the COT is obtained by the first wireless communication terminal by performing listen before talk (LBT) procedure.

16. The wireless communication method of claim 14, wherein the COT is obtained by the first wireless communication terminal by receiving a COT sharing information from the second wireless communication terminal.

17. The wireless communication method of claim 16, wherein the COT sharing information comprises at any one or more of:
a Channel Access Priority Class, CAPC, value,
a COT shared by the second wireless communication terminal,
a duration of a COT shared by the second wireless communication terminal, or
identification information of one or more devices allowed to use a COT shared by the second wireless communication terminal.

18. The wireless communication method of claim 16, wherein the performing the resource selection by the first wireless communication terminal in response to obtaining the COT sharing information comprises any one or more of:
triggering a resource reselection;
selecting a resource within obtained COT;
triggering a resource reselection in response to selected transmission resource that is not within obtained COT;
indicating the obtained COT to a lower layer;
randomly selecting a resource within a obtained COT in response to no sensing result existing in obtained COT;
selecting a resource within an intersection of a obtained COT and a sensing result of the first wireless communication terminal, in response to the first wireless communication terminal having the sensing result;
selecting a resource within a obtained COT randomly, in response to random selection being configured on a resource pool; or
selecting a resource within an intersection of obtained COT and a sensing result, in response to the first wireless communication terminal having the sensing result, and the resource is used for data to be transmitted to the second wireless communication terminal, in response to the COT is obtained by receiving the COT sharing information from the second wireless communication terminal.

19. A wireless communication terminal, comprising:
a processor configured to:
select transmission resources for a sidelink communication with a second wireless communication terminal; and
perform the sidelink communication with the second wireless communication terminal by using the selected transmission resource.

20. A computer program product comprising a computer-readable program medium code stored thereupon, the computer-readable program medium code, when executed by a processor, causing the processor to perform a method, comprising:
selecting transmission resources for a sidelink communication with a second wireless communication terminal; and
performing the sidelink communication with the second wireless communication terminal by using the selected transmission resource.
